(19) United States
(12) Patent Application Publication
(10) Pub. No.: US 2003/0059018 A1
(43) Pub. Date: Mar. 27, 2003

(54) Method and system to preclude call loop among services on a call server

(76) Inventors: Mello Eber, Ottawa (CA); Giuseppe Cinotti, Kanata (CA); Steven Szeto, Kanata (CA); Tu Do, Kanata (CA)

Correspondence Address: MARKS & CLERK, 350 BURNHAMTHORPE ROAD WEST, SUITE 402, MISSISSAUGA, ON, L5B 3J1, CA

(21) Appl. No.: 09/957,669

(22) Filed: Sep. 21, 2001

(51) Int. Cl. H04M 3/42

(52) U.S. Cl. 379/211.02

(57) ABSTRACT

Whenever a call is being established, a call loop may occur if a call server detects that the call is being re-routed back to a destination to which it has already been routed. Call loop is precluded by establishing a list of controlling services into which all re-routing services of parties who may be involved in the call are inserted. Each destination address for each call-leg is first treated as if it is a service address, and then as if it is a routable address. If the destination to which the call is being re-routed is the address of the party who modified the address, the call will proceed; otherwise any one of the following steps is followed: Returning a “busy” or “loop detected” message; treating the destination address as a routable address, and attempting to reach the network element associated with that address; offloading the call to another network element which is capable of resolving a call loop, or to the network element at the destination of the calling party.

### FIELD OF THE INVENTION

This invention relates to a method and a system to preclude call loop among services on a call server. In particular, the present invention is directed to both a method and a system which will detect and treat call loop during the establishment of a call, and thus preclude the eventuality of a call being forwarded indefinitely among call servers or among services on a single call server, due to the original destination of the call having been modified or re-routed by services.

### BACKGROUND OF THE INVENTION

Many services are offered by a telecom network, which may be a VOIP (Voice Over Internet Protocol) network, operating on its own or in association with a PSTN. Among those services is the capability of re-routing a call during its establishment.

In other words, as a call is being established, there may be some logic associated with a service which will control that call, whereby the destination of the call is modified according to one or more specific criteria as defined in the service definition.

Typical criteria which may establish when the destination of a call is to be re-routed, according to a re-routing service for any party to the call being established, may include the following: the identity of the calling party, the identity of the called party, the time of day the call is being established, the day of the week the call is being established, a pre-determined call distribution scheme, the original destination is busy, the original destination does not answer after a pre-determined period of time, and combinations thereof.

In the event of any such criteria arising, the service may decide to modify the destination of the call request, by forwarding the call to another destination. However, an undesirable consequence of this behaviour is that call loops may occur. A call loop will be deemed to have occurred whenever a call server detects that a call being established is being re-routed to a specific destination to which the call has already been routed. In other words, a call loop takes place whenever a call is forwarded indefinitely among call servers, or among services on a single call server.

Regrettably, it is virtually impossible to detect a call loop during service provisioning. This is because the network administration would need to consolidate all of the services that it provides, so as to verify that those services do not create call loop scenarios. Moreover, the network administration would have to consolidate the services against all services that are provided for by other networks. Those services on other networks may eventually interact with the services of still other networks, depending on the manner in which the call is established, where the destination address is, and so on.

As a consequence, call loop attempts must be detected and prevented by call servers that may be located anywhere on the network, during the establishment of the call.

### SUMMARY OF THE INVENTION

To that end, the present invention provides a method and a system to preclude call loop among services on at least one call server during call establishment through the at least one call server. Whenever a call is being established, there will be a call-leg established for each party to the call. At least two call parties will each own at least one re-routing service which is to be invoked each time that a call involving that party is to be established. That re-routing service for each party that owns such a service has as its purpose to modify the call being established by forwarding the call to another destination.

The present invention provides that a call loop shall be deemed to have occurred whenever the at least one call server detects that a call being established is being re-routed to a specific destination to which the call has already been routed. The method for precluding a call loop being established comprises the following steps:

(a) Establishing a list of controlling services into which all of the re-routing services are to be inserted for each party in the call that is being established, who owns such a call re-routing service.

(b) Treating each destination address first as if that destination address is a service address, and then as if that destination address is a routable address.

(c) In the event that the specific destination to which the call is being re-routed is the destination address of the party whose re-routing service has modified the destination address, permitting the call to proceed; otherwise proceeding with any one of the following steps:

(d) Returning a “busy” message or a “loop detected” message to the re-routing service which has modified the destination address to that specific destination.

(e) Treating the destination address as a routable address, and attempting to reach the network element associated with that routable address.

(f) Offloading the call being established to another network element which is capable of resolving a call loop, or offloading the call being established to the network element at the address of the calling party who initiated establishment of the call.

In keeping with the present invention, there may be a plurality of call servers that are interconnected by the network. Moreover, the list of controlling services may be distributed on the network among the plurality of call servers.

Still further, as previously noted, the re-routing service for any party to the call being established may arise as a consequence of different criteria, such as, but not limited to: the identity of the calling party, the identity of the called party, the time of day the call is established, the day of the week the call is being established, a predetermined call distribution scheme, the original destination is busy, the original destination does not answer after a pre-determined period of time, and combinations thereof.

The method of the present invention may further include the step of:

(g) Logging the loop attempt and notifying a network administrator accordingly.

The present invention also provides a system for precluding call loop among services on at least one call server that detects that a call being established is being re-routed to a specific destination to which the call has already been routed. The system comprises at least one call server onto which any party who is to be a party to a call to be established is required to register as respective re-routing service.

The system also comprises a list establishing and maintaining means onto which a list of controlling services of all of the re-routing services being established is inserted.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 shows a first scenario whereby a loop attempt occurs, to be detected by a call server;

FIG. 2 shows a different scenario where another loop attempt occurs, to be detected by a call server;

FIG. 3 illustrates a scenario where a service routes a call to the same destination address that triggered the execution of the service, but which does not result in a loop attempt; and

FIG. 4 shows another scenario where a service routes a call to the same destination address that triggered the execution of the service without a loop attempt occurring.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

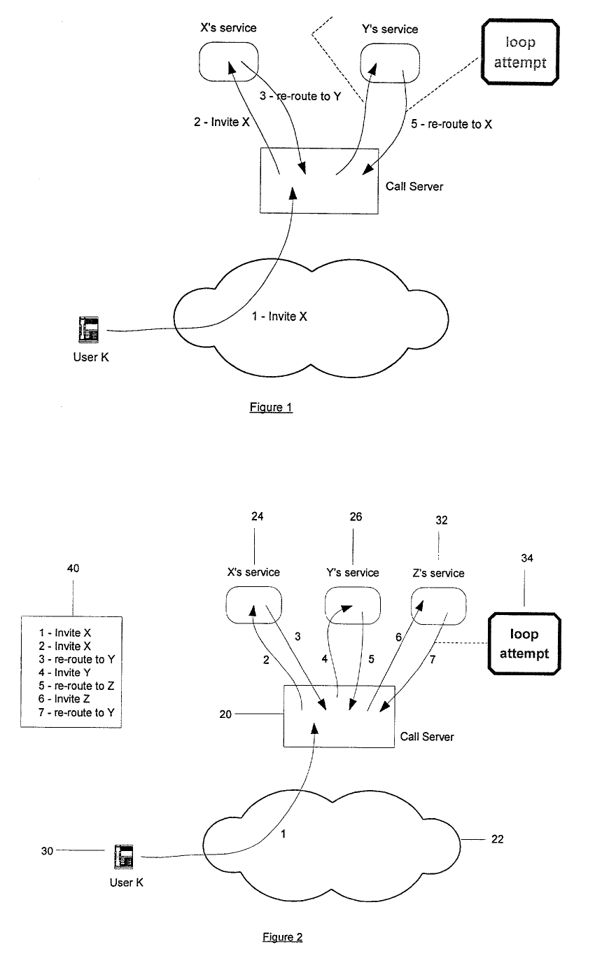

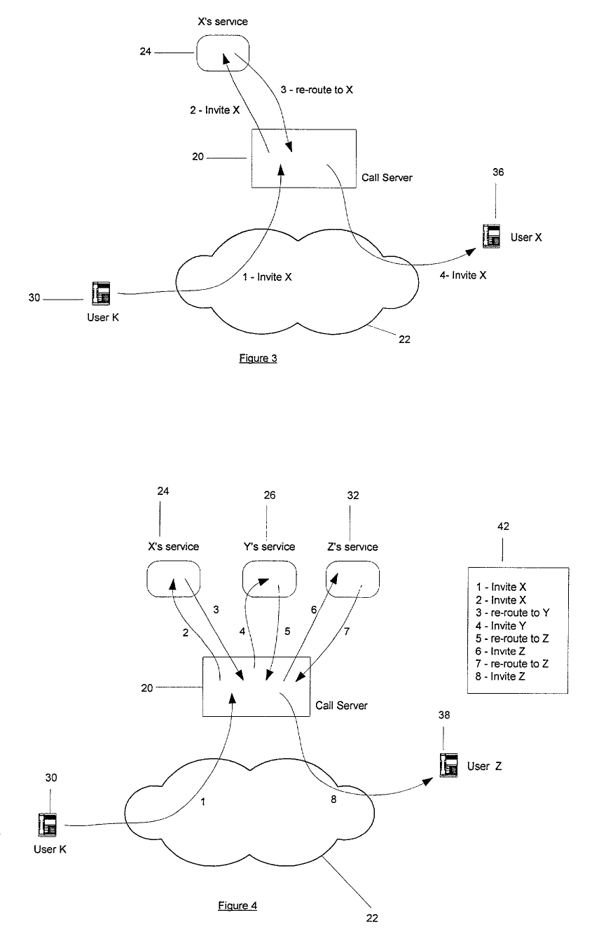

In the following discussion, user “K”, shown at 30, will be assumed to be the initiating caller, who is attempting to establish a call. Three other users are also assumed to be in th network, and they are user “X” who is shown at 36 in FIG. 3, user “Y”, and user “Z” who is shown at 38 in FIG. 4.

Each of users “X”, “Y”, and “Z” own a re-routing service, identified at 24, 26, and 32, respectively. The re-routing services are each registered on a call server 20.

The network 22 exists, through which calls may be initiated and carried. In each of FIGS. 1 to 4, the various steps that are taken during each call establishment attempt are numbered from 1 to 5, from 1 to 7, from 1 to 4, and from 1 to 8, respectively.

It shall be assumed for the sake of the following discussion that a service will issue the command “re-route Y” whenever it requests a call server to send the call to the destination “Y”. Of course, any message “Invite X” maybe sent by an endpoint or a call server, and the purpose of any such message is to forward a call to the destination “X”. At the same time, the message “Invite X” is also used by the call server to visit a service that is responsible for handling calls to “X”. In other words, whenever the call server receives an Invite request from the network, or a re-route request from a service, it will either send an Invite message to that destination address—if that destination does not have a service, or the service is located on a remote call server—or it will send the Invite message to the service which is locally located on the same call server that is responsible for handling calls to that destination.

The call server 20 will treat all of its services involved in controlling a call during its establishment as if those services were distributed on the network in different call servers. In other words, the services are kept on a list of controlling services which emulates the network order of those services, and the order which they would have incase each resided on a different call server.

However, when a service on a call server re-routes a call to a destination address that already has service on that call server controlling the same call, then a loop attempt is detected. There is an exception to that rule, and that is that when a service routes a call to the same address that triggered the execution of the service, there is no call loop or loop attempt which is detected. In the latter case, the destination address is considered to be a potential routable address—that is, an address which identifies a network element, as opposed to a service address. A service address is an address that identifies a service on the network, rather than a network element.

The exception which is noted above comes about because of a principle that only a service itself is capable of addressing a network element that bears the same address as that service. All other network elements and services cannot make this distinction, and therefore whenever another service sends an Invite message to a destination address, the destination address is first considered to be a service address. Only if there is no service associated with that address will the destination address be considered to be a routable address.

FIG. 1 shows an example of a loop attempt occurring. Step 1 sees an Invite message from user “K” to user “X” to join a call, which results in step 2 occurring as user “X's” service at 24 is invoked. This, in turn, results in step 3, whereby the call is to be re-routed to user

Step 4 sees an Invite message being sent to user “Y”, so that the call server 20 routes the call to user “Y”. That results in invocation of user “Y's” service which is shown at 26, and that is to re-route the call back to user “X”. A loop attempt is detected, as shown at 28.

In FIG. 2, the definition of each of steps 1 to 7 which are undertaken in that scenario is described in the box indicated at 40. Once again, user “K” issues an Invite to user “X”, resulting in user “X's” service at 24 re-routing the call to user “Y”, at step 3. In this case, however, user “Y's” service at 26 will re-route the call to user “Z”, at step 5.

However, user “Z's” service at 32 has been set up so as to also re-route any call intended for user “Z” back to user “Y”. This results in a loop attempt being detected, as shown at 34.

FIG. 3 illustrates a scenario which is successful, and wherein a loop attempt does not occur. Here, the Invitation to user “X” has resulted in user “X's” service at 24 in fact re-routing the call to user “X”, as shown at step 4, so that user “X” in fact receives the call. No loop attempt has occurred.

Likewise, in FIG. 4, the attempt by user “K” to establish a call to user “X” has, in fact, resulted in services of all of users “X”, “Y”, and “Z”, being invoked at 24, 26, and 32. User “X” re-routes the call to “Z”.

The above discussion gives rise to the following: The underlying principles that have been used to detect loop attempts described above also apply when multiple call servers interact with regard to the same call. If a call comes back to a call server that has already seen that call, then that call server will verify if the current destination of that call has a service already triggered and running on that call server. A loop attempt will then be characterized.

Whenever a loop attempt has been detected, the call server is then responsible for resolving that call, particularly if no other service that is controlling the call is either willing or capable of handling the loop attempt. Obviously, however, the treatment that is given by the call server to that call will not be the treatment which would normally be expected by each service which is controlling the call, since the consequence of allowing those services to continue handling the call would cause an infinite loop for the call because of the loop attempt which has occurred. So as to resolve those issues, the following steps have been adopted:

(a) Establishing a list of controlling services into which all of the re-routing services are to be inserted for each party in the call being established who owns such a call re-routing service.

(b) Treating each destination address for each call-leg being established first as if that destination address is a service address, and then as if that destination address is a routable address.

(c) In the event that the specific destination to which the call is being re-routed is the destination address of the party whose re-routing service has modified the destination address, permitting the call to proceed; otherwise proceeding with any one of the following steps:

(d) Returning a “reject” message with a reason of either “busy” or “loop detected” to the re-routing service which has modified the destination address to that specific destination.

(e) Treating the destination address as a routable address, and attempting to reach the network element associated with that routable address.

(f) Offloading the call being established to another network element which is capable of resolving a call loop, or offloading the call being established to the network element at the destination of the calling party who initiated establishment of the call.

One further step also will generally be invoked, which is the step of:

(g) Logging the loop attempt and notifying a network administrator that the loop attempt has been detected, so that the cause of the loop can be verified.

Discussion of the ramifications of a number of the steps described above now follow under several general headings noted below, with particular reference to steps (d) to (f) noted above, which are taken as solutions to the loop attempt treatment. Of course, it should be noted that in addition to the those steps (d) to (f), step (g) will normally also be taken because it is important for the call server to log any loop attempt and notify the network administration so that the cause of the loop can be verified.

Handle the Loop Attempt with a Busy Indication (Step d)

According to this step, whenever a call loop attempt is detected by the call server, the call server will return a “busy” message or a “loop detected” message to the calling service. If that calling service, or any other service on the list of controlling services, is capable of handling that “reject” message by attempting to re-route the call to yet another destination, then the call will eventually succeed. Otherwise, the caller will be given a “call failed” indication.

One possible undesirable side effect of this particular solution is that the caller might 10 get such a “call failed” indication, due to a loop attempt having been detected, right after the caller has received a positive provisional response from the call attempt. Such a provisional response might be that the destination is “alerting”. Nonetheless, the proposed solution resolves the attempt to establish a call loop in an otherwise satisfactory manner.

Treat the Called Service Number as a Routable Number (Step e)

In this step, whenever the call server detects a loop attempt to an address which is already on the list of controlling services, the call server will handle that destination address as a routable address and try to reach the network element which is addressed by that destination address —that is, the network element which is associated with that routable address. This follows from the principles which as been stated above, that only a service which itself is capable of addressing a network element is a service that bears the same address as the network element; and that all other network elements and services cannot make the distinction. Accordingly, by treating the called service number as a routable number, an attempt can be made to try to reach the network element which may be associated with that address.

However, an undesirable side effect for this step is that the service which handles calls to the address that caused the loop attempt will definitely not have its service logic honoured by the network. This is because the call server would have decided to bypass the logic for that service, in order to reach the destination address.

Return the Loop Attempt Towards the Caller (Step f)

This treatment calls for the call server to offload the responsibility to solve the loop attempt to some other network element which will eventually be the calling device, or to a network provided service that is capable of handling a loop attempt indication. Such a network provided service might be a service that will re-route the call to a network agent for further analysis.

It is assumed, of course, that in such circumstances the calling party will eventually lose patience, and terminate the call.

From the above discussion, it will be seen that the present invention provides a system for precluding call loop among services on a call server on a network, where the system includes at least one call server onto which any party who is to be a party to a call to be established is required to register its respective re-routing service. The system also includes a list of establishing and maintaining means on to which a list of controlling services of all of the re-routing services for any call being established, will be inserted.

There has been described a method and a system to preclude call loop among services on a call server. The present invention, in fact, describes a particular case which may arise from the scenarios described in a co-pending application filed simultaneously herewith, application Ser. No. ______, which application is directed to a method and system for controlling services logic interaction during call establishment.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

What is claimed is:

1. A method to preclude call loop among services on at least one call server during call establishment through said at least one call server, wherein a call-leg is established for each party to the call, wherein at least two called parties each own at least one re-routing service which is to be involved each time that a call involving that party is to be established, wherein that at least one re-routing service for each party has as its purpose to modify the call being established by forwarding the call to another destination, and wherein a call loop is deemed to have occurred whenever said at least one call server detects that a call being established is being re-routed to a specific destination to which the call has already been routed, said method for precluding a call loop to be established comprising the following steps:
(a) establishing a list of controlling services into which all of said re-routing services are to be inserted for each party in the call being established who owns such a call re-routing service;
(b) treating each destination address first as if that destination address is a service address, and then as if that destination address is a routable address;
(c) in the event that the specific destination to which the call is being re-routed is the destination address of the party whose re-routing service has modified the destination address, permitting the call to proceed; otherwise proceeding with any one of the following steps:
(d) returning a “busy” or “loop detected” message to the re-routing service which has modified the destination address to that specific destination;
(e) treating the destination address as a routable address, and attempting to reach the network element associated with that routable address; and
(f) offloading the call being established to another network element capable of resolving a call loop, or to the network element at the address of the calling party who initiated establishment of the call.

2. The method of claim 1, wherein there are a plurality of call servers interconnected by a network, and said list of controlling services is distributed on said network among said plurality of call servers.

3. The method of claim 1, wherein said re-routing service for any party to the call being established arises as a consequence of any of the group of determining criteria consisting of: the identity of the calling party, the identity of the called party, the time of day the call is being established, the day of the week the call is being established, a predetermined call distribution scheme, the original destination is busy, the original destination does not answer after a predetermined period of time, and combinations thereof.

4. The method of claim 1, further including the step of:
(g) logging the loop attempt and notifying a network administrator accordingly.

5. A system for precluding call loop among services on at least one call server during call establishment through said at least one call server, wherein a call-leg is established for each party to the call, wherein at least two called parties each own at least one re-routing service which is to be involved each time that a call involving that party is to be established, wherein that at lest one re-routing for each party service has as its purpose to modify the call being established by forwarding the call to another destination, and wherein a call loop is deemed to have occurred whenever said at least one call server detects that a call being established is being re-routed to a specific destination to which the call has already been routed, said system comprising:
at least one call server onto which any party who is to be a party to a call to be established is required to register its respective re-routing service; and
a list establishing and maintaining means onto which a list of controlling services of all of said re-routing services for any call being established is inserted.

6. The system of claim 5, wherein there are a plurality of call servers interconnected by a network, and said list of controlling services is distributed on said network among said plurality of call servers.

7. The system of claim 5, wherein said re-routing service for any party to the call being established arises as a consequence of any of the group of determining criteria consisting of: the identity of the calling party, the identity of the called party, the time of day the call is being established, the day of the week the call is being established, a predetermined call distribution scheme, the original destination is busy, the original destination does not answer after a predetermined period of time, and combinations thereof.
